(19) United States
(12) Patent Application Publication
(10) Pub. No.: US 2009/0205877 A1
(43) Pub. Date: Aug. 20, 2009

(54) Digital Scale with Detachable Platform

(75) Inventor: Christopher J. Claypool, Huntersville, NC (US)

Correspondence Address: LEMPIA BRAIDWOOD LLC, 223 W. JACKSON BLVD., SUITE 620, CHICAGO, IL, 60606, US

(73) Assignee: RUBBERMAID INCORPORATED, Huntersville, NC (US)

(21) Appl. No.: 12/323,015

(22) Filed: Nov. 25, 2008

Related U.S. Application Data
(60) Provisional application No. 61/029,904, filed on Feb. 19, 2008.

(51) Int. Cl. G01G 21/28

(52) U.S. Cl. 177/239

(57) ABSTRACT

A scale includes an instrumentation housing, a load sensor disposed within the instrumentation housing, a platform base spaced from the instrumentation housing for movement in communication with the load sensor, and a platform configured to support a load. In some cases, the platform is attached to the platform base via a snap-fit connection to apply the load to the load sensor. The platform is then detachable from the platform base to separate the platform from the instrumentation housing via a release of the snap-fit connection.

### CROSS-REFERENCE TO RELATED APPLICATION

This application claims the benefit of U.S. provisional application entitled “Digital Scale,” filed Feb. 19, 2008, and having Ser. No. 61/029,904, the entire disclosure of which is hereby expressly incorporated by reference.

### BACKGROUND OF THE DISCLOSURE

1. Field of the Disclosure

The present disclosure is generally directed to scales, and more particularly to scales having one or more detachable units or accessory components.

2. Description of Related Art

Scales that utilize electronics are commonly used in a variety of weight measurement contexts. Electronic transducers, such as strain gauges, develop an electrical signal representative of the amount of deflection caused by the weight of an object. The electrical signal is then processed so the result of the weight measurement can be indicated to a user. In this way, a digital display of the weight measurement can be provided. Digital displays are now a common user interface for a variety of scale types, including receiving scales, bench scales, ingredient scales, and bathroom scales.

Digital scales have been configured with a remote display to accommodate large items. For many weight measurements, the object to be weighed is larger than the platform of the scale. As a result, the scale is hidden underneath the object during the measurement. Under these circumstances, a display is positioned remotely from the main scale housing to provide a convenient way to obtain the measurement results. Scales having remote displays are often referred to as “pizza scales” in recognition of an ability to accommodate pizza-sized items.

Digital scales are used in a wide variety of industrial, laboratory, food preparation, and other contexts that often subject the scales to dirty or messy environments. The scales are, as a result, frequently cleaned for compliance with regulations or other reasons. The remote displays of the scales may also need to be cleaned in some environments or contexts. Unfortunately, the scales are often difficult or inconvenient to clean for a number of reasons.

### BRIEF DESCRIPTION OF THE DRAWINGS

Objects, features, and advantages of the present invention will become apparent upon reading the following description in conjunction with the drawing figures, in which like reference numerals identify like elements in the figures, and in which:

FIG. 1 is a front, perspective view of one example of a digital scale constructed in accordance with one or more aspects of the disclosure including an integrated carrying handle.

FIG. 2 is a front, perspective view of another example of a digital scale constructed in accordance with one or more aspects of the disclosure including a detachable digital user interface unit releasably coupled at a link that allows the scale to be carried with and without the unit attached.

FIG. 3 is a rear, perspective view of the exemplary digital scale of FIG. 2 to depict storage feet configured and positioned along a side face in accordance with another aspect of the disclosure.

FIG. 4 is a top view of the exemplary digital scale of FIG. 2 to further depict the positioning and arrangement of several features on respective sides of the scale in accordance with another aspect of the disclosure.

FIG. 5 is a bottom, perspective view of the exemplary digital scale of FIG. 2 to depict a cord management system configured and positioned in accordance with another aspect of the disclosure.

FIG. 6 is a front, elevational view of the exemplary digital scale of FIG. 2 to depict the cord management system and other aspects of the scale in greater detail.

FIG. 7 is a side, elevational view of the exemplary digital scale of FIG. 2 to depict the cord management system and other aspects of the scale in greater detail.

FIG. 8 is a partial, exploded, perspective view of the exemplary digital scale of FIG. 2 to depict the display unit in a disengaged position remote from an instrumentation unit having a surface configured to engage with the digital scale in accordance with another aspect of the disclosure.

FIG. 9 is a cross-sectional view of the exemplary digital scale of FIG. 2 taken along the lines 9-9 of FIG. 4 to depict the engagement of respective, mating surfaces of the display unit and the instrumentation unit in accordance with another aspect of the disclosure.

FIG. 10 is an exploded, perspective view of the exemplary digital scale of FIG. 2 to depict an alternative connection of the digital display unit and the instrumentation unit and a platform assembly constructed in accordance with one or more aspects of the disclosure.

FIG. 11A is a perspective view of the platform assembly of FIG. 10 to depict one example of a platform retention mechanism in accordance with one embodiment.

FIG. 11B is an exploded, perspective view of the platform assembly of FIG. 10 after the release of the retention mechanism.

FIG. 12 is a front, perspective view of another example of a digital scale constructed in accordance with one or more aspects of the disclosure, including a detachably secured digital display unit and a carrying handle.

FIG. 13 is a front, perspective view of yet another example of a digital scale constructed in accordance with one or more aspects of the disclosure, including rubberized exterior surfaces for secure handling.

FIGS. 14-19 are front, perspective views of further examples of digital scales having alternative configurations of one or more of the features described and shown in connection with the other disclosed examples, including a detachable digital display unit, a side handle(s), a cord management mechanism, and a side foot (or feet).

### DETAILED DESCRIPTION OF THE DISCLOSURE

The disclosure is generally directed to scales equipped with various features, and the disparate accessories or components supporting the features, that nonetheless remain easily conveyed, cleaned, stored, and otherwise handled. The designs of the scales render them well suited for frequently re-location or re-positioning. As a result, the disclosed scales can be conveniently moved, for instance, in the food preparation context for cleaning. The designs of the disclosed scales also facilitates re-location of the scales to a storage location. In some ways, the disclosed scales are configured to avoid the unfortunate drops or other mishandling during these activities. That is, to facilitate cleaning and use of the scales more generally, some aspects of the disclosed designs are generally directed to features that enhance the portability of the scale. As described below, the disclosed scales may include a carrying handle suitably positioned to avoid interfering with weight measurements. The scales described herein are also generally designed to address the portability challenges while incorporating one or more disparate accessory components. For example, the disclosed scales may have one or a plurality of accessories detachably secured to respective surfaces or sides of an instrumentation unit in a manner that allows the scale to be transported or carried with or without the accessory(ies). As a result, the functionality of the scales is enhanced without complicating or hindering cleaning operations, transportability, storage, etc.

Some aspects of the disclosure are directed to a user interface or display unit that can be remotely positioned from the site or location of an instrumentation unit, yet also securely joined with the instrumentation unit for easier conveyance of the scale. In some cases, the interface or connection of the instrumentation and user interface units is established or facilitated by a magnetic element that provides a robust attachment, while simplifying the surfaces involved for easier cleaning. In these and other ways, the scales described herein are generally configured for compatibility with dirty or messy environments and, thus, frequent cleaning.

Further aspects of the disclosure are directed to other accessories that can also be detachably or removably secured to the instrumentation unit. As described below, the instrumentation unit may have a platform assembly with a platform retained in position during weight measurements, and then detachable or releasable from the instrumentation unit for cleaning, etc. In some cases, the platform is detachably secured to the instrumentation unit via a snap-fit connection. More generally, the connection of the platform allows the instrumentation unit to be carried with or without the platform attached thereto.

Another exemplary accessory that may be removably secured to the instrumentation unit is a cord that connects the user interface and instrumentation units. In several of the examples described below, the cord can be removably secured or stored unobtrusively along an exterior surface of the instrumentation unit, such as the bottom side of the instrumentation unit. Storage of the cord along the bottom side helps to avoid complications during weight measurements, while also making it more convenient to transport the scale.

Some aspects of the disclosure are directed to accommodating a plurality of structural features, components, or accessories of the disclosed scales while still configuring the scale for secure and convenient carriage, storage and other handling, and without compromising or otherwise undesirably impacting the use of the scales. As described below, the disclosed scales may include a number of the following structural features compatibly arranged along respective sides or surfaces of the instrumentation unit: (i) platform engagement and retention; (ii) side storage feet; (iii) an integrated handle; and, (iv) cord management.

While many aspects of the disclosure are generally directed to the portability of the scales, some features of the disclosed scales are also useful independent of the transportability, safe handling, or convenient storage of the scales. For instance, the cord management feature of some of the disclosed scales may be useful in unobtrusively arranging or removably securing a cord that connects the user interface and instrumentation units. While this aspects of the disclosure may help with portability and safe handling, practice of this aspect of the disclosed scales is not limited to portable scales. The disclosed scales are also not limited to any one particular use context or environment, such as the food preparation context. Still further, while some aspects of the disclosure involve the digital operation or configuration of the scales, other aspects of the disclosure are not limited to use with digital or electronic scales or any digital or electronic aspects thereof.

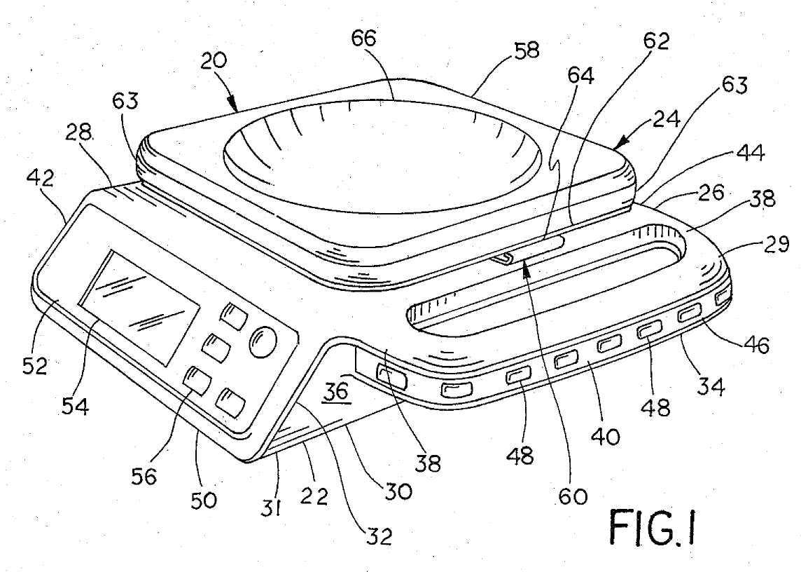

Turning now to the drawing figures, FIG. 1 shows one example of a digital scale 20 configured in accordance with several aspects of the disclosure. The digital scale 20 has a number of components integrated within an instrumentation unit or housing 22 to perform a number of weight measurement and other functions in connection with a load applied to a platform assembly 24. The platform assembly 24 is spaced from the housing 22 to allow the load to deflect or move the platform assembly and, in turn, deflect or move one or more load sensors (not shown) coupled thereto. The load sensing components of the scale 20 are generally disposed within an enclosure or shell 26 of the housing 22. In this example, the enclosure 26 may be formed from a multiple-piece shell in which an upper cover 28 forms a top side or surface 29 of the enclosure 26 and a lower cover 30 forms a bottom side or surface 31 of the enclosure 26. For instance, the upper and lower covers 28, 30 may be formed as a two-piece construction, joining via a snap-fit, press-fit or other engagement to form a two-piece shell, in which case the upper and lower covers 28, 30 define an interface 32 along lateral or other sides or surfaces of the enclosure 26. The interface 32 may form or include a watertight seal that runs the perimeter or circumference of the housing 22. The watertight seal may be useful for protecting electronic and other sensitive components, such as the load sensor(s), housed within the enclosure 26. Despite the foregoing, the manner in which the internal components of the digital scale 20 are enclosed or housed may vary considerably as desired, such that the shape, form, construction, and other structural characteristics of the housing 22 are exemplary in nature.

The digital scale 20 has a carrying handle 34 to facilitate safe handling during cleaning operations, relocations for storage, and other transport. The handle 34 generally extends from a lateral side or surface 36 joining the top surface 29 and the bottom surface 31. In this example, the handle 34 is integrated with the enclosure 26, forming an integral extension of the lateral side 36. More specifically, a pair of laterally spaced apart projections 38 extend outwardly from the rest of the lateral side 36 to meet a handle grip 40 that links the pair of projections 38. The projections 38 and the handle grip 40 are horizontally oriented, such that the handle 34 generally runs the width (or depth) of the lateral side 36 to extend substantially between front and rear sides 42, 44 of the enclosure 26. In these ways, the projections 38 and the handle grip 40 form a generally C-shaped extension of the lateral side 36. The handle 34 may be spaced from the bottom side 31, or positioned at a height along the lateral side 36, such that a user can grasp the handle grip 40 without having to pick up the scale 20. The handle grip 40 may include a rubberized or otherwise tactile band 46 to provide a non-slippery or non-smooth surface well-suited for secure handling. To that end, the band 46 of this example has a plurality of indentations 48 spaced along the length of the handle grip 40. The band 46 may be an integrated part of the handle grip 40 as, for example, an insert in a groove sized to receive the band 46. The band 46 may be part of an over-mold or other exterior layer disposed on other surfaces of the housing 22, e.g., the bottom side 31, to prevent sliding or other undesired displacement of the scale 20 during use. Nevertheless, the band 46 need not run the entire length of the handle 34 as shown.

In this example, the handle 34 is disposed near the top surface 29 of the enclosure 26. In fact, the top of the handle 34 and the top surface 29 are roughly at the same height, as the handle 34 may be formed as an extension of the upper cover 28 of the enclosure or shell 26. The handle 34 has a tubular shape resulting from the junction of the upper and lower covers 28, 30. Notwithstanding the foregoing, the position and orientation of the handle 34 along the lateral side 36 may vary from the example shown. Other structural characteristics of the handle 34 may also vary considerably as desired.

Some aspects of the disclosure are directed to accommodating or integrating disparate accessories or components of the scale 20 in a manner that does not interfere or hamper the use or operation of the other accessories or components, or the weight measurement function itself. As described herein, several accessories or components of the digital scale 20 are generally arranged in a configuration that generally enhances portability, simplifies storage, and remains compatible the weight measurement-related instrumentation of the digital scale 20. Moreover, the portability and storage of the scale 20 is not hampered by one or more components of the digital scale 20 that may be detachable to facilitate cleaning, repair or replacement, customization, etc. As described below, one example of a detachable component involves the platform assembly 24.

Another example of these aspects of the disclosure involves the arrangement of components of the scale 20 relative to the handle 34. Generally speaking, the arrangement of components relative to the handle facilitates safe handling and portability of the scale 20. In the example shown, a display interface 50 is positioned along the front side 42 of the housing 22, but alternatively may be disposed along any one or more of the other lateral sides of the housing 22. The display interface 50 and the handle 34 are on different lateral sides in this example so that user interaction with the interface 50 is not obstructed by the handle 34, and vice versa. Similarly, the handle 34 is positioned and oriented a safe distance away from the platform assembly 24. In these ways, the handle 34 does not conflict or interfere with weight measurements or use of the display interface 50. Still further, carrying the scale 20 via the handle 34 is unlikely to lead to a situation where the user rests the scale 20 upon the display interface 50 because the handle 34 and the display interface 50 are arranged on adjacent lateral sides. Instead, carrying the scale 20 via the handle 34 may result in a storage placement of the scale 20 on the lateral side opposite of the lateral side 36.

The display interface 50 in this example is an integral extension of the front side 42. The display interface 50 includes a front panel 52 that generally runs the width (or length) of the front side 42 and extends generally from the top side 29 to the bottom side 31 of the enclosure 26. In these ways, the front panel 52 extends outwardly from the remainder of the enclosure 26 for convenient access and use. In this example, the display interface 50 progressively extends farther outward near its bottom side, such that the front panel 52 is oriented at an angle relative to the generally horizontal surfaces of the top and bottom sides 29, 31. The angled nature of the front panel 52 and, more generally, the construction of the display interface 50, are generally directed to avoiding a situation where a user is forced to pick up the scale 20 to interact with the display interface 50. The front panel 52 in this example is formed from, and includes, a portion of the upper cover 28 of the enclosure 26, such that the electronics and other internal components associated with the display interface 50 are protected by the watertight seal of the upper and lower covers 28, 30. Notwithstanding the foregoing, the shape, position, orientation, and other structural characteristics of the display interface 50 may vary considerably as desired.

The functional characteristics and components of the display interface 50 may also vary considerably. In this example, the front panel 52 includes a display screen 54 and any number of user select buttons 56. The display screen 54 may, for instance, include a liquid crystal display (LCD), a touch sensitive display (or touch screen), and any desired number of associated visual elements to support or supplement the weight measurement information and other content displayed. One of the user select buttons 56 may be configured, for example, as a power off/on switch, while others may be used to toggle between types of information to be displayed, thereby customizing or adjusting the display screen 54. A variety of other functions and operations can be implemented or controlled via the user select buttons 56.

In this example, a platform 58 of the platform assembly 24 is detachably secured to the housing 22. For the reasons set forth below, the scale 20 may be carried, stored or otherwise handled with or without the platform 58 attached. The platform assembly 24 generally includes a number of components directed to supporting or accommodating an item to be weighed, while transferring its load to the weighing instrumentation for the measurement. These components may, for instance, provide a supportive base to which the platform 58 is releasably attached. In this example, the platform 58 is configured as a cover platform that acts as a cap or upper layer of the platform assembly 24 on which the item is placed. The platform 58 covers the other components of the platform assembly 24 and, more generally, the scale 20 to protect against spills, dirt, contamination, etc. Moreover, the platform 58 is coupled to the other components in a manner that generally transfers the load of the item for measurement by the scale 20. To that end, the platform 58 is spaced from the enclosure 26 to support the load above one or more load sensors (not shown) disposed within the housing 22. The load sensor(s) are generally securely seated or fastened within the housing 22. The platform 58 is generally positioned relative to the load sensor(s) such that the load is directly or indirectly applied to the load sensor(s) in a manner suitable for an accurate weight measurement. The details regarding the structural support of the load sensor(s) within the housing 22 may vary considerably. While the structural details of the connection between the platform 58 and the load sensor(s) may also vary, the platform 58 and at least one load sensor are releasably coupled so that the scale 20 can be carried via the handle 34 both with and without the platform 58 attached. In this way, the scale 20 may be carried without requiring a user to hold the platform 58 in position against the other components of the scale 20. For these and other reasons, the scale 20 is highly portable despite the conveniences provided by a detachable platform.

The attachment and detachment of the platform 58 may be accomplished in a variety of ways. In the example shown in FIG. 1, the platform assembly 24 includes a release mechanism 60 configured to disengage or detach the platform 58 from a platform base 62 disposed between the platform 58 and the enclosure 26. In this way, the platform 58 acts as a cover for the platform base 62, and is referred to as such for ease in description of this example. The platform base 62 and the cover platform 58 may be configured to engage one another via, for instance, a press-fit or snap-fit connection that is released via actuation of the release mechanism 60. In this example, the cover platform 58 is configured as a cap having edges or sides 63 shaped to engage corresponding surfaces of the platform base 62. To that end, the platform base 62 may be shaped as an insert to fit within the cap and engage each of the edges or sides 63. In some cases, the platform base 62 includes a platform-shaped insert, in which case the platform base 62 and the cover platform 58 form a nested arrangement when attached.

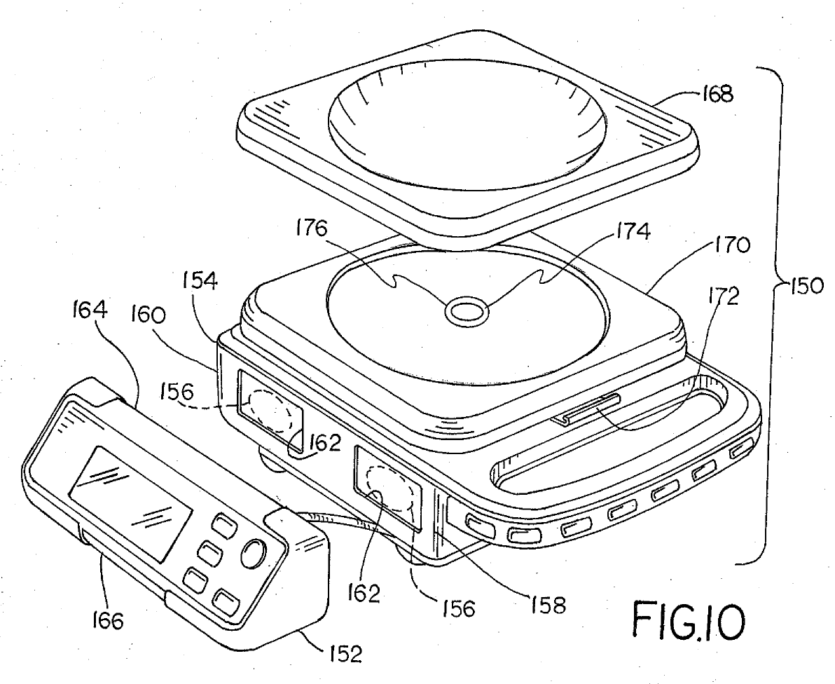

Regardless of the respective shapes and fit of the cover platform 58 and the platform base 62, the release mechanism 60 in this example includes a release lever 64 configured to be pulled, pushed, deflected, or otherwise displaced to disengage a latch or lock (not shown) acting as a retention mechanism establishing the connection to keep the cover platform 58 in place. In general, the release aspects of the mechanisms may include a projection extending from beneath the platform base 62 or other component of the assembly 24 to be accessible to a user. In this example, the release lever 64 and, more generally, the release mechanism 60 extend laterally from the space between the platform base 62 and the enclosure 26 of the housing 22. The release lever 64 or other projection may then be coupled via a link to the lock or latch disposed beneath the cover platform 58 or otherwise located in a generally inaccessible position within the platform assembly 24. Further details regarding exemplary retention and release mechanisms for the detachable platform are provided below in connection with FIGS. 10, 11A, and 11B.

The platform base 62 may be fixedly coupled to the load sensor and, thus, movably secured to the housing 22. To that end, one or more components of the platform assembly 24 is spaced from the enclosure 26 to allow the deflection or other movement resulting from the application of the load to the cover platform 58. The movement, in turn, may then cause corresponding deflection of, or within, the load sensor in connection with the measurement. When the platform base 62 includes a platform-shaped insert nested within the cover platform 58, the insert is also spaced from the enclosure 26. This spacing also allows the release lever 64 or other component of the release mechanism 60 to be positioned between the platform base 62 and the enclosure 26. In that way, the release mechanism 60 can act upon the platform assembly 24 during a release or disengagement of the cover platform 58.

The shape and structure of the platform assembly 24 may vary considerably from the example shown. A wide variety of other shapes, sizes and configurations may be incorporated into the cover platform 58. For instance, the cover platform 58 need not have a rectangular perimeter, or a circular, bowl-shaped depression 66 centered within the perimeter as shown. In some cases, for example, the cover platform 58 may be configured with one or more exterior ridges or other structures in addition to, or as an alternative to, the depression 66 to help retain the load upon the scale 20 during the measurement. The attachment and arrangement of the cover platform 58 and the platform base 62 may also vary as desired. For instance, the cover platform 58 need not have edges that wrap around the outer or exterior surfaces of the platform base 62 as in the example shown. In fact, the lateral extent of the cover platform 58 need not exceed the exterior surfaces of the platform base 62, in which case the cover platform 58 and the platform base 62 may stack with the platform base 62 on the exterior. The platform base 62 itself may vary considerably, as it need not be platform-shaped. In some cases, the platform base 62 provides a skeletal framework to which the cover platform 58 is detachably secured. Any type, shape, or form of undercarriage or prop may be used for the platform base 62.

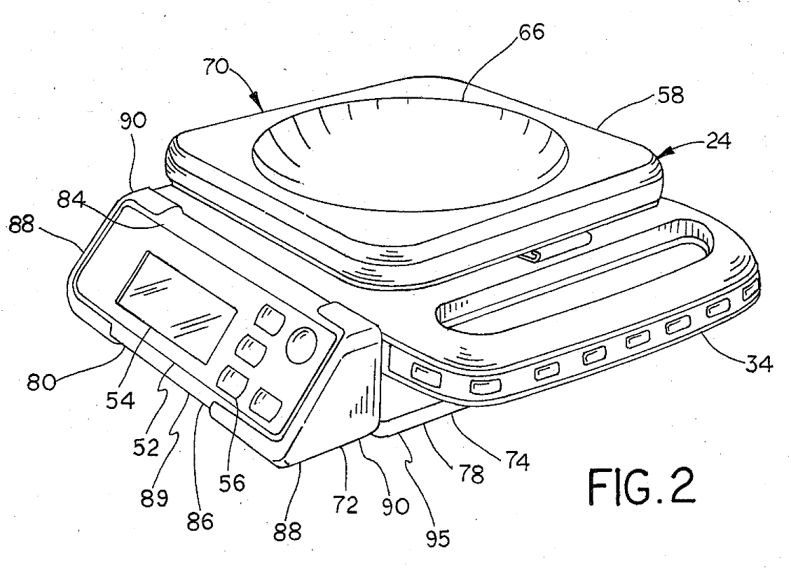

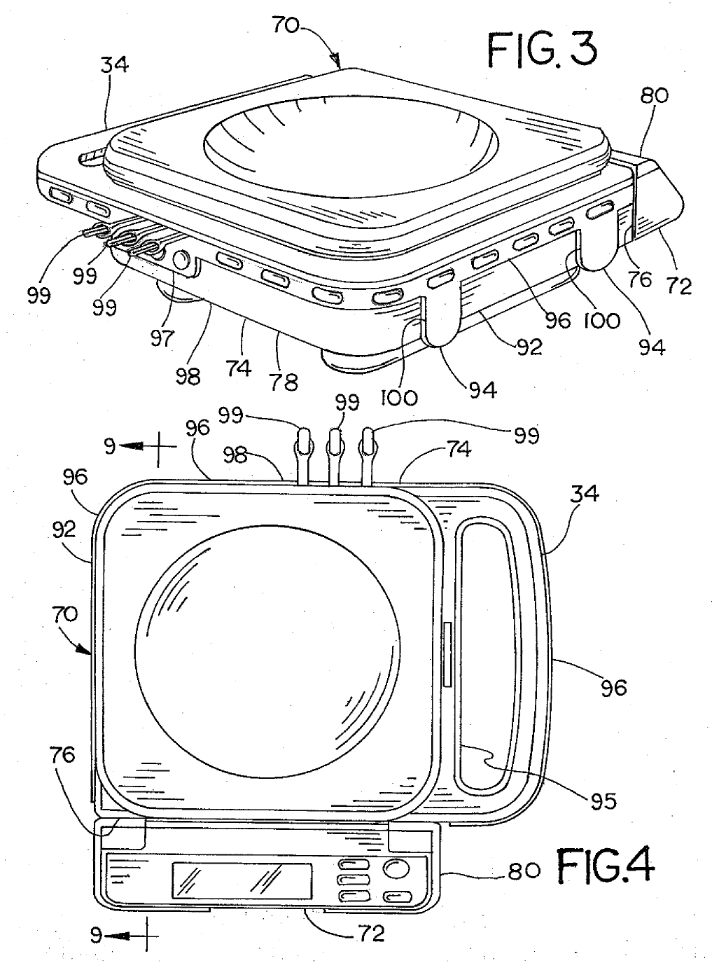

FIGS. 2-7 depict another exemplary scale 70 incorporating a number of aspects of the disclosure, including several in common with the example of FIG. 1. For instance, both examples include the detachable cover platform 58 and the carrying handle 34 positioned on respective sides or surfaces of the enclosure 26. In these and other ways, the scale 70 is also configured for portability, convenient storage and cleaning, etc., as described above. User control of the scale 70 may also similar, except that in this case the scale 70 has a user interface unit 72 detachably or releasably secured to an instrumentation unit 74. In this example, the user interface unit 72 and the instrumentation unit 74 form a connection or interface at a side face 76 (FIGS. 3 and 4) of a housing 78 of the instrumentation unit 74. The positioning of the user interface unit 72 is therefore similar to the positioning of the display interface 50 of the scale 20 shown in FIG. 1. However, once the connection or interface between the units 72, 74 is disengaged, the user interface unit 72 can be separated from, and remotely positioned relative to, the instrumentation unit 74. The separation may be useful when the size of the load or other circumstances would otherwise block access to the user interface unit 72.

The user interface unit 72 may be secured to the instrumentation unit 74 at the connection or interface in a variety of ways. As described below, the interface may include or involve a magnetic connection in some cases. To that end, one or more magnets may be disposed along the side face 76 within the housing 78 as part of the instrumentation unit 74, within the user interface unit 72, or both. Alternatively or additionally, the interface between the units 72, 74 may include or involve a mechanical connection, such as a cooperative interface involving, for instance, a base, seat, or other mount (not shown) shaped to receive a cooperatively shaped structure (not shown) on the user interface unit 72. Alternatively or additionally, the cooperative interface involves one or more lateral projections and corresponding detents to receive the projection(s). In these and other cases, the interface need not include or involve a latch or lock to hold the user interface unit 72 securely in place. Nonetheless, the user interface unit 72 can generally remain attached to the housing 78 via the connective aspects of the interface described herein. The user interface unit 72 can thereafter be released and moved to a remote position relative to the location of the instrumentation unit 74, as desired.

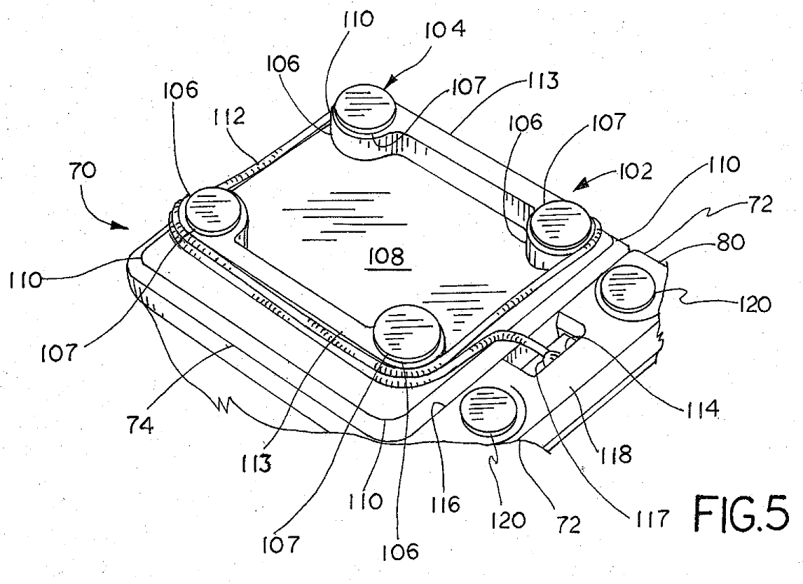

Communications between the user interface unit 72 and the instrumentation unit 74 may be established in various ways. As described below, the interface between the units 72, 74 may include a cable or cord (FIG. 5) having one or more communication lines to carry data, information and other signals. In some cases, the cable may also carry power to or from one of the units 72, 74 to support the operation of the other unit. In other cases, communication and/or power delivery may include or involve one or more wireless protocols or other techniques, including, for instance, infrared transmissions and Bluetooth connectivity. The units 72, 74 may also be configured to rely on separate sources of power, including but not limited to battery power.

The components and characteristics of the user interface unit 72 may be similar to, or vary from, those of the display interface 50 of the scale 20 shown in FIG. 1 to any desired extent. For ease in illustration, the user interface unit 72 is depicted in FIG. 2 with the same display, panel, and other interface elements of the display interface 50 of the scale 20.

As best shown in FIGS. 2 and 4, a housing 80 of the user interface 72 may be wedge-shaped to facilitate user interaction with the interface elements and to otherwise provide the advantages set forth in connection with the above-described example. To those ends, the housing 80 has a front face 82 oriented at an angle to extend less outward (or forward) at a upper face 84 than at a lower face 86 of the housing 80. The housing 80 may, but need not, be watertight or waterproof, and may be formed as an integrally molded construction or involve any number of components in snap-fit or other attachment.

Portions of the housing 80 of the user interface unit 72 may be covered in one or more layers 88. In some cases, the layers 88 are over-molded layers or other coatings applied to the housing 80. The layers 88 may also be formed from one or more wraps or sleeves applied to the housing 80 as an exterior layer. In either case, the layers 88 may be configured as a friction-enhancing or grip-enhancing surface to prevent slippage of the unit 72 when disposed on a counter or other smooth surface. In this way, the sleeves 88 may also facilitate secure handling and/or serve to protect the unit 72 from damage resulting from bumps or other impacts. The sleeves 88 may also have a thickness that displaces a central section 89 of the user interface unit 72 from the surface upon which the unit rests, thereby reducing the likelihood of contact with liquids or other undesirable substances. In this example, the sleeves 88 include a pair of end caps 90 shaped and configured to engage respective ends of the housing 80. The end caps 90 may be connected by a strip or other link (not shown) running along the lower face 86. To help hold the end caps 90 in position, the end caps 90 may include fingers or other projections that extend beyond the respective ends of the housing 80 to reach the front face 82, the upper face 84, and the lower face 88. Alternatively or additionally, an adhesive or other fastener may be used. The end caps 90 may be formed from any suitable material, including, for example, a rubber-like or rubberized material having a tactile or other non-slippery surface that may be stretched to fit the shape of the housing 80. These and other structural characteristics of the housing 80 and the user interface unit 72 may vary considerably as desired. For example, in some cases, the end and other portions of the housing 80 may include one or more integral caps of any desired material, including the material of the housing 80 itself.

When attached or mounted as shown in FIG. 2, the housing 80 of the user interface unit 72 may be elevated along the side face 76 (FIGS. 3 and 4) of the housing 78 of the instrumentation unit 74. The elevation may be minimal, but sufficient to maintain separation from the underlying surface for a variety of reasons. For instance, the slight elevation may leave sufficient spacing below the housing 80 (especially the central section 89) to allow a user to lift the unit 72 off the mount or to otherwise detach the unit 72 without having to lift or move the instrumentation unit 74. Alternatively or additionally, the slight elevation may be useful in connection with reducing the likelihood of contact with liquids or other substances present on the underlying surface.

The housing 80 of the user interface unit 72 need not run the length of the side face 76 as shown. Rather, the housing 80 may be sized to have a width that does not extend beyond the length of the side face 76 so as to not complicate storage and other handling. More generally, the housing 80 may be sized, shaped, mounted, or positioned relative to the instrumentation unit 74 in a variety of ways. Thus, the construction and configuration of the housing 80 may vary considerably from that shown.

FIG. 3 shows another feature or component of the scale 70 directed to facilitating portability, storage, and other handling. In accordance with this aspect of the disclosure, the housing 78 of the instrumentation unit 74 has a lateral side 92 having a number of storage feet 94 configured to support the scale 70 in a non-use position. This example includes a pair of storage feet, although the number may vary. The storage feet 94 generally provide a stable base for the scale 70 when in the non-use position, in which the scale 70 rests on one of the sides of the housing 78. To that end, the storage feet 94 may be spaced from one another along the side 92 of the housing 78. In this example, the storage feet 94 are disposed on the side 92 of the instrumentation unit 74 opposite that of a lateral side 95 (FIGS. 2 and 4) from which the handle 34 extends. In this way, a user can carry the scale 70 via the handle 34 after re-orienting the scale from its standard posture or orientation to one in which the side 92 having the storage feet 94 faces downward. The scale 70 can then be conveniently placed on the storage feet 94 to re-orient or arrange the scale 70 in a compact, or space-saving, orientation convenient for storage in which the scale 70 stands on end, in this case, a lateral side (e.g., the side 92). As a result, carrying the scale 70 via the handle 34 promotes safer and more secure handling and placement when not in use. In this example, the scale 70 may be stored or placed in this orientation with or without the user interface unit 72 attached, as the unit 72 is positioned on the side 76 and otherwise sized and configured not to interfere with storage in the non-use position or storage orientation, as described above. Furthermore, and as described below, the attachment of the user interface unit 72 and other accessories to the instrumentation unit 74 is not dependent upon a specific orientation of the housing 78, in which case the accessories remain attached despite carrying via the handle 34 and storage in the non-use position.

The storage feet 94 generally project from the lateral side 92 an extent to establish that the storage feet 94 are the contact points for the scale 70 when it rests in the non-use position, or storage orientation. In this example, the storage feet 94 have a thickness roughly commensurate with the thickness of a band 96 similar to the band 46 described above. Thus, in some cases, the band 96 may also act as part of a base, or a contact point, such that the scale 70 rests on the feet 94 as well as the band 96 in the non-use position. In fact, the feet 94 and the band 96 may be formed from the same material, in which case the feet 94 may be integrally formed therewith as extensions of the band 96. A connector port panel 97 may, but need not, be also formed integrally with the band 96. The band 96 roughly runs the width of the side 92, and may continue around the housing to be disposed on another lateral side 98 of the housing 78 (opposite of the side 76) and the handle 34, as described above. The connector port panel 97 may be disposed on the lateral side 98, so as to not interfere with the handle and storage features described above. A number of port plugs 99 may be secured to, and extend from, the lateral side 98 to seal or otherwise close the ports of the connector panel 97 when not in use. In some cases, the plugs 99 may be made of a rubberized material similar to the material used for the feet 94 and the band 96.

One or more of the side feet 94 may vary from the tab-shaped form of the example shown having a flat contact surface 100. The contact surface 100 may have any desired shape, surface area, and material layer configuration. In some cases, the surface 100 may be a friction-enhancing or grip-enhancing over-mold or other layer. In this example, the surface 100 is a rubberized or other tacky layer to avoid sliding or slipping in the non-use position.

FIGS. 5-7 present several additional views of the scale 70 to depict a cord management system indicated generally at 102. In this example, the cord management system 102 is integrated with a base 104 of the housing 78 of the instrumentation unit 74. The base 104 includes a number of footing posts 106 that project downward from a bottom side or surface 108 of the housing 78. Each post 106 may have a lower or base pad 109 configured in a manner similar to that of the lower side feet 94 to provide a stable foundation for the instrumentation unit 74. In this example, the posts 106 are generally spaced from one another around a periphery of the bottom side 108, with each corner 110 of the bottom side 108 having a respective one of the posts 106. The spacing of the posts 106 generally allows a cord or cable 112 (FIG. 5) for the user interface unit 72 to be stored under the instrumentation unit 74. Storage of the cord 112 can help avoid interference with a weight measurement when the user interface unit 72 is attached to (or otherwise disposed near) the instrumentation unit 74. Moreover, storage of the cord 112 under the instrumentation unit 74, i.e., along the bottom side 108, may help keep the cord 112 clean.

The cord management system 102 may have any number of projections from the bottom side 108 in addition to the posts 106. For example, the example shown in FIGS. 5-7 includes a pair of bars 113 (FIGS. 5 and 7) extending and connected between respective pairs of the posts 106. Each bar 113 projects downward from the bottom side 108 such that the cord 112 runs along the outer surface of the bar 113 when engaged with the cord management system 102. Generally speaking, the projections are configured to removably secure the cord 112 to the instrumentation unit 74 in a manner that allows the cord 112 to remain connected to both the instrumentation unit 74 and the user interface unit 72 regardless of whether engaged with the cord management system 102. To that end, the cord 112 may have a certain length designed to be wrapped around the posts 106 and other projections a specified extent (e.g., a predetermined number of times or turns) before extending into a socket area 114 (FIG. 5) of the user interface unit 72 for the connection. The socket area 114 may be a recessed region in a rear side 116 of the housing 80 of the user interface unit 72 sized and shaped to accommodate a terminal plug 117 of the cord 112. The socket area 114 may also be formed in, and open to, a bottom surface 118 of the housing 80, as shown in FIG. 5. In this example, the socket area 72 is disposed between a pair of footer pads 120 directed to stabilizing the user interface unit 72 when not attached to the instrumentation unit 74.

Each bar 113 need not be integrally formed with the posts 106 as shown in FIGS. 5 and 7. Alternative cases may include bars or bar-like projections unattached or distinctly separate from the posts 106. Alternatively or additionally, the cord management system 102 includes bars or other projections running between or connecting the posts 106 on the other sides of the housing 78. In general, the shape, size, length, positioning, material, and other structural characteristics of the components of the cord management system 102 may vary considerably from the example shown. For instance, the bars 113 may include a groove or other recession in which the cord 112 is received.

The cord management system 102 may be configured to accommodate cords, cables or other connectors in addition to the cord 112 responsible for carrying data, information and other communications between the instrumentation unit 74 and the user interface unit 72. For example, one or more power cords (not shown) may also be received for storage along the bottom side 108, as well as to keep them from interfering with the other features and aspects of the scale 70—whether while in-use, in storage, and in transport via the handle 34.

The number and positioning of cord wrap projections may vary from the example shown. For instance, not all of the projections need to be located on the bottom face 108 of the housing 78. Further, one or more of the cord wrap projections may not be spread outwardly to the corners 110, but may be otherwise positioned or arranged, for example, to minimize the number of times the cord wraps around the projections.

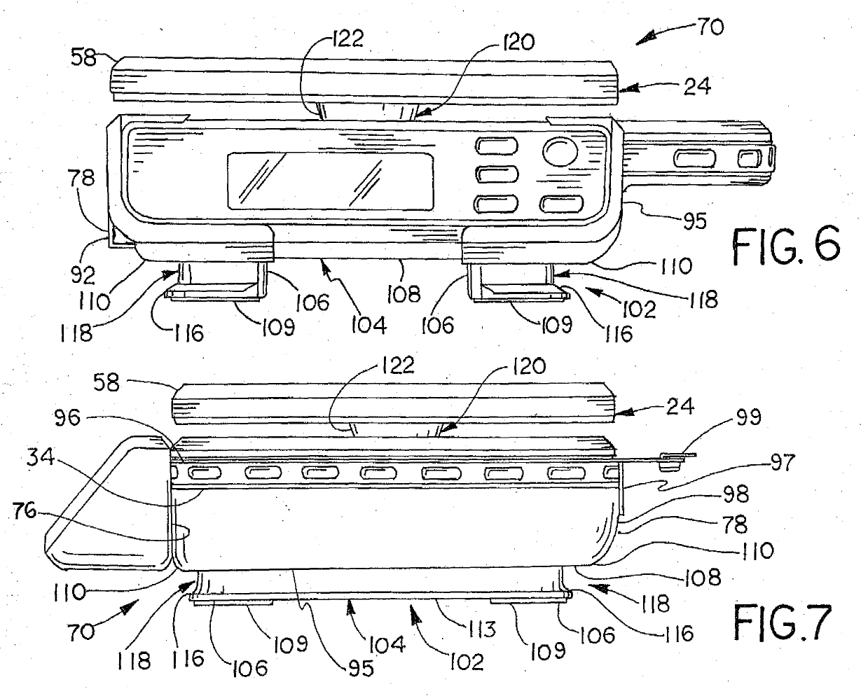

FIGS. 6 and 7 depict the cord management system 102 without the cord 112 wrapped around the posts 106 and the projecting bars 113. As best shown in FIGS. 6 and 7, each post 106 or other projection may include a protruding collar or ledge 116 that extends laterally outward to define a groove or slot 118 in which the cord 112 is received. The ledge 116 may or may not correspond with the pads 107 or other flattened surfaces on which the scale 70 rests in an in-use position. For example, each post 106 or other projection has an L-shaped cross-section to engage the cord 112 and include a pad or other distributed and flattened support surface. In some cases, the ledge 116 extends along the bars 113 rather than just around outer edges of the posts 106 as shown. In either case, the cord 112 can then be held in place within the grooves 118 after being wrapped around the posts 106 and other projections. This secure engagement of the cord 112 allows the scale 70 to be carried via the handle 34 and stored in the side upright position described above without interference from the cord 112. Moreover, with the projections on the bottom face, the cord does not interfere with storage in the upright position described above. More generally, the cord management system 102 allows the cord to be stored during use without destabilizing the scale 70.

FIGS. 6 and 7 also schematically depict a load sensor assembly 120 in communication with the cover platform 58 and, more generally, the platform assembly 24. The load sensor assembly 120 includes a load sensor 122 of any conventional type and configuration. For example, the load sensor 122 may include a load cell, strain gauge, or other spring-based transducer, the deflection of which is indicative of the load applied to the platform 58. In this case, the scale 70 includes a single, centralized load cell, but more generally may include any number of load cells distributed around the platform assembly 24. More generally, each load sensor 122 includes a number of components generally disposed and movable within the housing 78 of the instrumentation unit 74. The details and arrangement of the components of the load sensor 122 may vary considerably, but generally speaking, the load applied to the platform 58 causes a deflection or other movement detected by the load sensor 122. The detection of the movement results in the generation of a signal indicative of the applied weight to be sent via the cord 112 (FIG. 5) to the user interface unit 72. In this example, the load sensor 122 is securely seated or fastened within the housing 78 in a central location relative to the lateral sides of the housing 78, i.e., relative to the corners 110 and the posts 106. The structural support of the load sensor 122, and the manner in which the sensor is secured, within the housing 78 may also vary considerably, as desired.

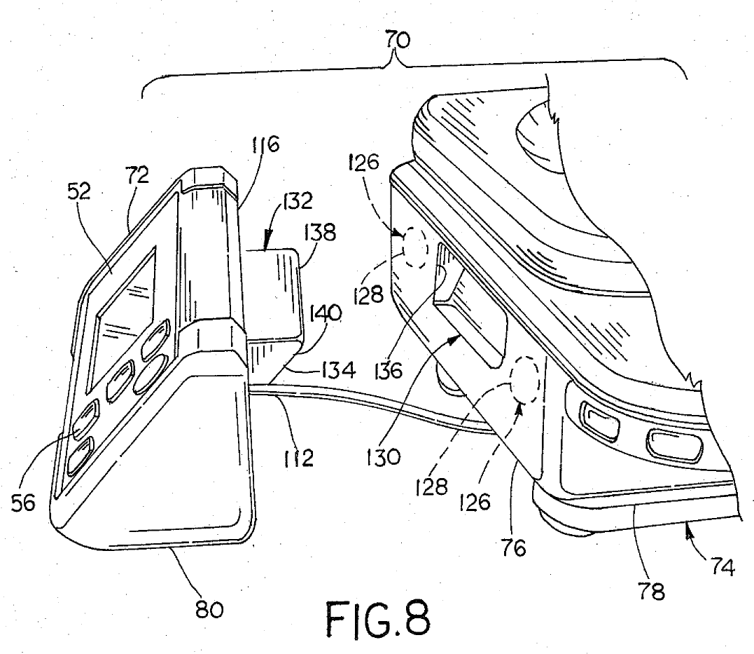

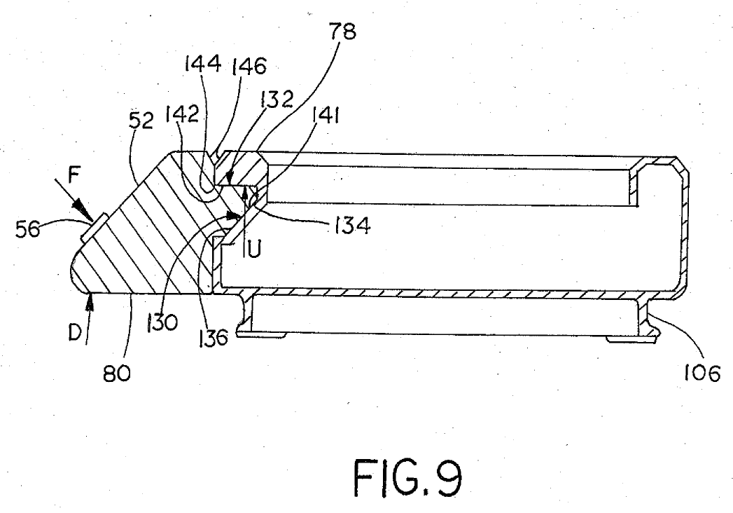

FIG. 8 shows the scale 70 with the user interface unit 72 detached from the instrumentation unit 74 to illustrate further aspects of the disclosure. The re-engagement of the user interface and instrumentation units 72, 74 is then shown in the cross-section of FIG. 9 to further illustrate these aspects of the disclosure. These aspects generally include or involve a contoured and continuous interface between the units 72, 74 that nonetheless allows the user interface 74 to be both easily detached and securely engaged when attached. Although these aspects of the disclosure are presented in connection with the scale 70, these aspects need not have any of the above-described features and accessories described in connection with the scale 70. Instead, these aspects may be optionally and compatibly incorporated with one or more of the above-described features and accessories, as desired.

In accordance with one aspect of the disclosure, the remote positioning of the detachable user interface unit 72 is facilitated by a magnetic connection that secures the user interface unit 72 to the housing 78 of the instrumentation unit 74. To that end, one or more magnetic areas 126 may be disposed along the lateral side 76 of the housing 78. In this example, the magnetic areas 126 are laterally spaced apart from one another along the side 76 to distribute a magnetic field and, thus, a corresponding attractive force for the user interface unit 72. The housing 80 of the user interface unit 72 is then generally configured with another magnet, a metal layer, a metal component, or other element, capable of being attracted by the magnetic field. Each magnetic area 126 in this example includes a respective magnet 128 located within the housing 78 behind the surface of the side 76, in which case the areas or sections of the housing 80 of the user interface unit 72 may, but need not, include a magnet(s) to establish the magnetic attraction. In other cases, the magnetic area(s) 126 of the housing 78 of the instrumentation unit 74 may not include magnets, but rather be capable of being magnetized by one or more magnets disposed within or on magnetic areas (not shown) of the user interface unit 72. Thus, the source(s) of the magnetic force, such as one or more magnets, may be part of the user interface unit 72, the instrumentation unit 74, or both. In any case, the user interface unit 72 can therefore be easily attached and detached from the housing 78 of the instrumentation unit 74 and moved to a position remote from the housing 78, as desired. Furthermore, the magnetic force provides for a secure engagement of the user interface and instrumentation units 72, 74, thereby facilitating storage and other handling of the scale 70 as an integrated device (i.e., without having to carry the units separately).

While the location of the magnets can vary between the units 72, 74, other characteristics of the magnet(s) 128 may also vary considerably from the example shown, including without limitation the number, positioning, size, shape, type, and material properties of the magnet(s) 128. For instance, the degree to which the magnet(s) are integrated or disposed within the sides 76 or 116 may include or involve mounting the magnet(s) behind the surface within the housing 78 or 80. Alternatively, each magnet 128 may be disposed within a respective aperture (not shown) formed in one of the sides 76, 116. In these cases, each magnet 128 does not project outwardly from one of the sides 76, 116, such that the sides 76, 116 may remain flat, smooth, and generally vertical for a flush engagement of the units 72, 74. In other cases, the magnet area(s) 126 or the magnet(s) 128 may be affixed or mounted to the exterior surface of one of the housings 78, 80 via an adhesive or other fastener. The other side facing the mounted magnet may then include a corresponding recession in which the magnet is received, which may, but need not, form a part of the feature described below.

The interface between the units 72, 74 may also be contoured to facilitate the connection in accordance with another aspect of the disclosure. With continued reference to the example shown in FIGS. 8 and 9, the side 76 of the instrumentation unit 72 has a surface 130 shaped to cooperate with a surface 132 of the side 116 of the user interface unit 72. In this example, the interface includes or involves a pair of complementary faces having a projection 134 and a matching indentation 136. When the complementary faces of the sides 76, 116 meet, the projection 134 is received within the indentation 136 to strengthen the connection. In this way, the strength of the magnetic connection may be decreased or minimized, thereby allowing smaller, less expensive magnets or magnet arrangements to be used. In this example, the projection 134 and the indentation 136 form a single, matching pair disposed on the sides 76, 116, although other embodiments may have any number of matching pairs. Furthermore, the complementary shapes, sizes, positions, and other characteristics of the projection 134 and the indentation 136 may vary as desired.

In some cases, the projection 134 and the indentation 136 may have matching angled faces shaped and oriented to facilitate the disengagement of the units 72, 74, while also maintaining the engagement during use. The angled faces generally allow an upward lift of the housing 80 to remove the projection 134 from the indentation 136, and generally translate the actuation of one of the user interface elements into an upward force on the projection 134 to maintain the connection (e.g., the engagement of the projection and indentation). In this example, the projection 134 is shaped as a wedge 138 with an angled or tapered surface 140 that generally faces downward and rearward relative to the remainder of the housing 80. As a result, the surface 140 has an upward slope at an angle of, for example, 45 degrees, as the wedge 138 projects outward from the housing 80. The indentation 136 then includes an inclined surface 141 in complementary fashion to the angled surface 140. The angle, incline, or taper of the surfaces 140 and 141 need not be commensurate or generally aligned with the angle or slope of the panel 52 of the user interface unit 72, as shown in FIG. 9, but in some cases similar angles may be helpful as described below. This wedge-based example is described with the understanding that a wide variety of other mated surfaces may be used to align or position the units and otherwise facilitate the magnetic engagement.

The angled orientation of the projection 134 and the tapered surface 140 allow the connective interface between the units 72, 74 to withstand, if not benefit from, a user's application of force to one of the buttons 56 of the panel 52. Generally speaking, the positioning and configuration of the projection and the indentation (and the matching surfaces thereof) maintain the connection even when force is applied to the panel 52 of the unit 72. More specifically, the force is generally applied in a direction F perpendicular to the panel 52, a component of which is, in turn, generally translated by the slope of the panel 52 into an upward force U applied to a ceiling surface 142 (FIG. 9) of the indentation 136. To this end, the button 56 may be disposed at a height on the panel 52 such that the force tends to try and rotate the user interface unit 72 in a manner that promotes the translation of the direction of the force to the upward direction U. Alternatively or additionally, the wedge 138 may be disposed at a height on the side 116 (e.g., more than halfway up the side) to promote the force translation.

The wedge-shaped nature and orientation of the projection 134 also generally facilitate a release or disconnection in which the units 72, 74 are disengaged by a generally upward force in a direction D applied as shown in FIG. 9. Generally speaking, the projection 134 and the matching indentation 136 are shaped to allow the housing 80 of the user interface unit 72 to rotate or pivot out of the connection. The rotational direction is generally opposite to that caused by the application of the force F during use. In this example, the generally upward force D causes the tapered or sloped surfaces of the projection 134 and the indentation 136 to slide relative to one another as the housing 80 generally pivots about an upper edge 144 (FIG. 9) of the interface. Top surfaces 146 (FIG. 9) of the housings 78, 80 may also be beveled to allow the rotational movement.

As shown in FIG. 9, the housing 80 of the user interface unit 72 may be disposed at a height spaced from the surface upon which the scale 70 rests to provide a user with space to reach under the housing 80 to lift upward for disengagement as described above. The spacing or height of the housing 80 need not correspond with the height of the posts 106 as shown in the example of FIG. 9. In these cases, the housing 80 of the user interface unit 72 is positioned more generally at any desired height that provides sufficient space for a user to position a hand or fingers under the housing 80 to lift upward. To this end, the positions of the projection and indentation, as well as the size of the housing 80, may be modified accordingly. As a result, the projection 134 and the indentation 136 may be positioned at different relative heights along the sides 76, 116, respectively. For example, the indentation 136 may be located closer to the top of the side 76 than the projection 134 is located relative to the top of the side 116.

With or without the complementary faces or matching surfaces, the magnetic connection described above generally presents a simplified interface between the user interface and instrumentation units 72, 74. One way in which the interface is simplified involves the absence of any mechanical fasteners or other moving parts to establish the connection. For instance, clips, latches, or other locking fasteners are not necessary to hold the user interface unit 72 in place against the housing 78 of the instrumentation unit 74. The absence of locking fasteners on either side of the connection may facilitate cleaning and improve durability. In addition to being lock-free, the sides or exterior surfaces involved in the interface are non-perforated or unbroken so that the housings or enclosures (or at least one or more sides thereof) can be continuous and/or sealed, which may be useful for waterproofing the units to facilitate cleaning, etc. To this end, any magnets involved in the interface may be disposed behind the exterior surfaces as shown in the figures. As described above, the sides may still have contoured surfaces to position and align the units and otherwise facilitate the connection. Moreover, these advantages are provided without hampering the portability of the scale 70, insofar as the scale 70 may still be carried via the handle 34 with the user interface unit 72 attached via the magnetic connection described above.

The positioning of the projection 134 is also compatible with those embodiments incorporating both the wedge-shaped interface and the recessed socket area 114 of the cord management system. In some cases, the wedge or other projection may be disposed above the recessed socket area 114 shown in FIG. 5. Positioning the projection above the socket area 114 may facilitate the translation of forces described above, as the projection pivots or rotates about a point higher than most, if not all, of the buttons of the panel 52.

Turning now to FIG. 10, a scale 150 is depicted to illustrate another aspect of the disclosure, as well as another example of a magnetic interface connection between a user interface unit 152 and an instrumentation unit 154. The scale 150 may but need not also incorporate other accessories or features, such as the handle and cord management features described above. The scale 150 has an alternative magnet-based connective interface in which a pair of magnet areas 156 are disposed on a lateral side 158 of a housing 160 of the instrumentation unit 154. Each magnet area 156 is generally located in a respective indentation or depression 162 in the side 158 and configured to receive a matching or complementary bump or other projection (not shown) laterally extending from a rear side 164 of a housing 166 of the user interface unit 152. In this way, the engagement of the bump and the depression 162 may generally help to inhibit relative sliding or other movement of the housing 166 relative to the housing 160 in the plane of the interface. As a result, the magnet areas 156 remain generally aligned with the areas on the housing 166 to which they are attracted, and disconnection of the units need not involve or require movement other than a lateral separation of the bumps from the depressions 162.

The example of FIG. 10 also depicts one embodiment of a platform retention mechanism directed to maintaining a connection between a cap or cover platform 168 on which items to be weighed are placed and the remainder of the instrumentation unit 154. In some cases, the platform retention mechanism allows the platform 168 to remain connected regardless of the orientation of the scale. For instance, the platform 168 may remain engaged with the instrumentation unit 154 in both an in-use orientation and a storage or handling orientation. In that way, the scale may be conveniently carried via the handle or stored on side storage feet with the platform 168 attached.

FIG. 10 also illustrates an aspect of the retention mechanism generally directed to the disengagement of the platform 168 from the remainder of the instrumentation unit 154. Generally speaking, it may be useful at times to disengage the platform 168 for cleaning, maintenance, replacement, etc. To this end, the platform 168 is configured to releasably engage one or more components of the instrumentation unit 154. As in the example described above, the platform 168 of this embodiment is part of a platform assembly having a platform base 170 and a release mechanism 172. In this example, the platform base 170 is also generally shaped and otherwise configured to form a snap-fit connection with the platform 168. As described above, the platform base 170 is also plate- or platform-shaped such that the platform 168 and the platform base 170 stack in a nested arrangement. As a result, the platform base 170 in this example may be configured to act as a sub-platform disposed underneath the platform 168. More generally, the platform base 170 is spaced from the housing 160 of the instrumentation unit 154 to allow the load to move the platform assembly and thereby deflect the load sensor(s) (not shown) disposed within the housing 160. In this example, the platform base 170 is coupled to a single load sensor centered relative to the platform base 170. The coupling of the platform base 170 and the load sensor may be secured via a single fastener 174, such as a screw fastener, disposed within a recess 176 in the platform base 170. More generally, the platform base 170 and other components of the platform assembly are in communication with the load sensor(s) via any desired mechanical or structural link.

With reference now to FIGS. 11A and 11B, further details regarding an exemplary snap-fit connection between the platform 168 and the platform base 170 are provided. While a variety of snap-based, pressure-fit, and other fasteners are suitable for releasably engaging the components of the platform assembly, the snap-fit connection is useful because a separate tool, clip, latch, or other mechanical structure is not necessary to assemble or disassemble the platform assembly. As a result of the snap-fit connection, the platform 168 and the platform base 170 may be injection-molded products with the snap-related features, including any release mechanism, integrated therein. Nonetheless, a variety of fabrication techniques, materials, and structural designs of the platform assembly are well-suited for this aspect of the disclosure. For example, one or both of the platform 168 and the platform base 170 may be formed from a sheet of stainless steel or other metals stamped into a plate-shaped cap, cover, or structural frame. These and other examples may provide the resilient components for a pressure-fit, snap-fit, or other connection, although the assembly may include non-resilient materials as well or instead.

In this example, the platform 168 is shaped as a cap or cover with a plate-shaped top or upper surface 180 having a rectangular or square shape when viewed from above. The top surface 180 extends outward from a central, circular depression 182 to lateral sides 184 bent downward from the generally horizontal orientation of the top surface 180. The sides 184 extend around the perimeter of the top surface 180 to form a rim. In this case, the rim includes an inner, angled or beveled skirt 185 and an outer, generally vertically oriented skirt 186 extending downward from the angled skirt 184. Together, the skirts 184 and 186 are configured to provide protection for spills impacting the instrumentation unit 154 sideways by wrapping around the exterior of the platform base 170. In some cases, the sides 184 (or any skirts thereof) may extend downward beyond the platform base 170 to further limit the spread of spills.

The rim formed by the skirts 184 and 186 also facilitates the releasable engagement of the platform 168 and the platform base 170. In this example, each lateral side 184 terminates at a lower edge or end 188 such that the top surface 180 and the sides 184 form a downward-facing cavity or space in which the platform base 170 is received. The platform base 170 may then be configured as an insert with surfaces shaped in a complementary fashion relative to the platform 168. For example, the platform base 170 has a plate-like top or upper surface 190 having a central depression 192 to accommodate the depression 182 of the platform 168. The top surface 190 extends laterally outward to sides 194 bent downward and running along a perimeter of the top surface 190 to form another rim. The rim is shaped to match the rim of the platform 168, with the sides 194 including an angled skirt 196 and a generally vertically oriented skirt 198. The top surface 190 may extend laterally to an extent that the platform base 170 fits within the space defined by the platform 168 as shown in FIG. 10, and to an extent that allows tabs 200 on each side 184 of the platform 168 to engage a snap-fit ramp 202 on the platform base 170. The snap-fit ramp 202 has an angled face 204 that extends laterally outward from one of the sides 194 and, in this example, the skirt 198. The lateral extent of the angled face 204 increases from top to bottom. As a result, an inwardly projecting lip 206 of one of the tabs 200 is deflected outward as the tab 200 rides or slides down the ramp 202. Eventually, the lip 206 reaches a ledge 208 at the end of the ramp 202, snapping over the ledge 208 to form the snap-fit connection. The configuration of the snap-fit connection, including the shapes, positions, and other structural characteristics of the components involved, may vary considerably from the example shown. For instance, detents other than the ramp 202 may extend from the platform base 170. In other cases, the detent may be formed on an inner surface of one of the sides 184 of the platform 168.

The platform 168 may be symmetrical to facilitate engagement with the platform base 170 in any one of several orientations. In this example, each side 184 of the platform 168 includes a respective one of the tabs 200. Because each tab 200 includes one of the lips 206, the platform base 168 has a notch 210 formed in each side 194 not having the snap-fit ramp 204. In this way, the platform 168 may engage the platform base 170 with any side 184 positioned to engage the snap-fit ramp 204.

A release mechanism for the above-described snap-fit connection is now described. In this example, one of the sides 194 of the platform base 170 includes a lever 212 configured to displace the snap-fit ramp 204 and thereby release the platform 168. The snap-fit ramp 204 is mounted on an outward surface of the lever 212 such that the resilient deflection of the lever 212 moves the snap-fit ramp 204 inward. As a result, the lip 206 eventually clears the ledge 208, and is allowed to ride up the ramp 204. Springs 214 disposed on the top surface 190 of the platform base 170 may be used to bias the platform 168 toward disengagement, thereby causing the platform 168 to move upward after the lip 206 clears the ledge 208. In this case, the springs 214 are formed from cutouts of the top surface 190 of the base 170, as shown.

The lever 212 may be an integral part of the platform base 170. In this example, the lever 212 is formed by two generally vertical cuts in one of the sides 194, thereby freeing the portion of the side 194 between the cuts to pivot or deflect from the default position. To that end, the lever 212 includes a ledge 215 outwardly protruding from a lower edge of the skirt 198. The ledge 215, in turn, terminates in an upstanding ridge 216 that presents an exterior surface 217 on which a user can apply a force, pushing inward to disengage the connection. With the lever 212 linked to the remainder of the base platform 170 as shown, a downward force applied to the ridge 216 may also disengage the connection, as part of the force is redirected inward through the pivoting motion of the lever 212. The lateral extent of the ledge 215 may also be useful in positioning the ridge 216 (or other component of the release mechanism) beyond the platform 168, as shown in FIGS. 1, 2, 6, and 10, so that a user can easily access the release mechanism when the platform and base are engaged.

The structural configurations of the retention and release mechanisms may vary considerably from the example shown in FIGS. 11A and 11B. A wide variety of arrangements of resilient tabs, fingers, cantilevers, and other projections may be incorporated or integrated into the platform assembly, either integrally or otherwise, to flexibly engage a projection or detent on an opposing surface of either the platform 168 or the base 170. Furthermore, the number, position, size, lateral extent, principal of operation, and other characteristics of the release lever or other mechanism may also vary.

The construction and configuration of the springs 214 may also vary considerably. In the example shown in FIG. 11B, each spring 214 integrally formed from the platform base 170. More specifically, each spring 214 includes a flat, strip-shaped cutout from the top surface 190 of the base 170 bent into an upwardly biased tab 218 capable of elastic compression toward the remainder of the top surface 190 of the base 170. In this way, each spring 214 slopes upward from a fixed point in a cantilevered spring configuration. However, other spring configurations or arrangements may be used, as the springs 214 need not be based on upwardly biased tabs 218 as in the example shown. For instance, the springs 214 may include a variety of compression springs disposed either in or on the plate or other structure that forms the top surface 190 of the base 170. In other cases, the springs 214 need not be part of, or coupled to, the platform base 170. Instead, one or more of the springs 214 may be secured to the underside of the top or upper surface 180 of the platform 168.

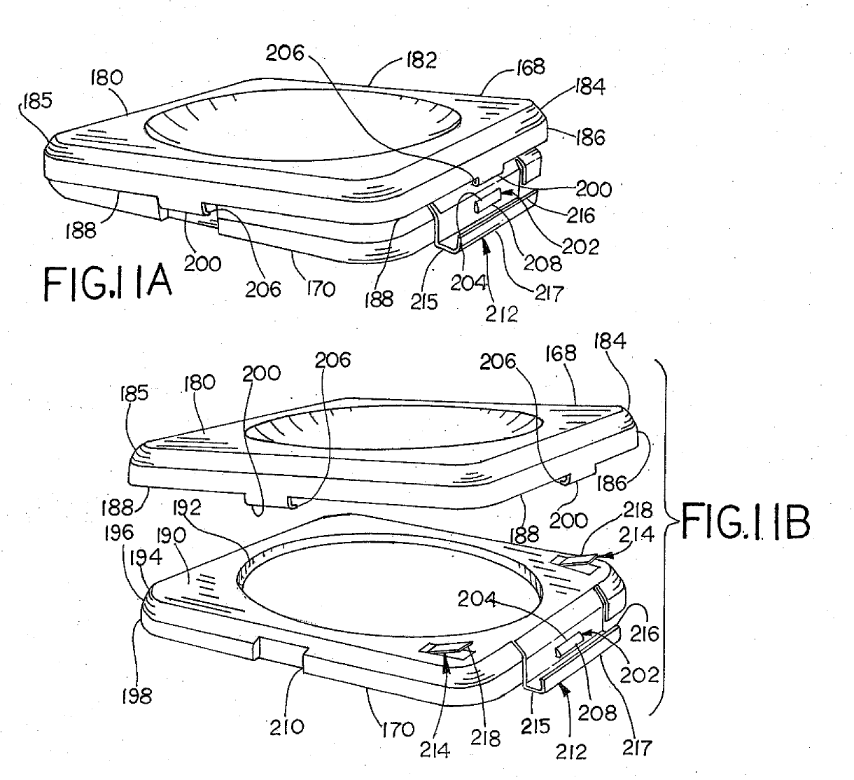

Turning now to FIG. 12, a digital scale 220 provides another example of a detachable digital display or user interface unit 222 and an instrumentation unit 224 with an integrated handle 226. In this case, the user interface unit 222 and the handle 226 are disposed on opposite sides of a housing 228 of the instrumentation unit 224. The user interface unit 222 is detachably secured to the housing 228 via a magnetic connection involving a single magnetic area 230 along a side 232 of the housing 228. The magnetic area 230 may be located within a recessed face or panel 234 in the side 232 configured to receive a matching or complementary projection (not shown) on a rear face of a housing 236 of the user interface unit 222.

The exemplary digital scale 220 illustrates a number of alternative configurations of the accessories described above. For instance, a platform assembly 238 spaced from the instrumentation housing 228 has a cap or cover platform 240 configured to cover completely an underlying framework or undercarriage (not shown). The cover platform 240 also has a rounded front side 242 instead of the beveled and vertical skirts disposed on other lateral sides 244. This asymmetry in the design of the cover platform 240 may, for instance, be useful in connection with orienting the platform cover 240 for assembly.

The digital scale 220 also presents an alternative arrangement of gripping surfaces. Instead of a strip of grip-enhancing layers or surfaces, lateral sides 245 of the instrumentation housing 228 share a lower side panel 246 formed of a grip-enhancing, friction-enhancing, or tacky material, including an overlayer 247 of a rubberized material. The panels 246 are separated from, or not integrated with, a gripping surface 248 disposed on the handle 226. The housing 236 of the user interface unit 222 has a depression 250 on each lateral side 252 to facilitate disengagement from the instrumentation housing 228 and other handling.

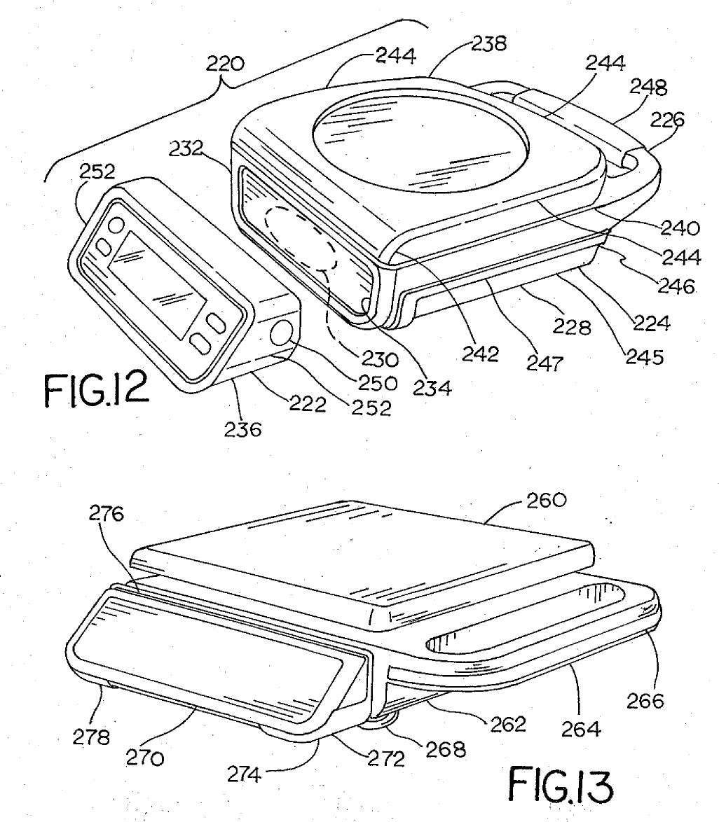

FIG. 13 shows an exemplary digital scale 260 having yet another arrangement of grip-enhancing or friction-enhancing material layers. In this example, an instrumentation housing 262 has an integrated handle 264 with a grip-enhancing strip 266. Other exterior surfaces of the instrumentation housing 262 with a grip-enhancing or friction-enhancing material may be limited to the bottom surfaces of feet or posts 268 on which the housing 262 stands. A detachable user interface unit 270, in contrast, includes a grip-enhancing or friction-enhancing layer 272 with lateral sides 274, a rear side or surface 276, and bottom surfaces 278 to cover corresponding surfaces of the user interface unit 270. The layer 272 may cover the entire rear side of the user interface unit 270, insofar as the user interface unit 270 and the instrumentation housing 262 may be attached via a magnetic connection as described above.

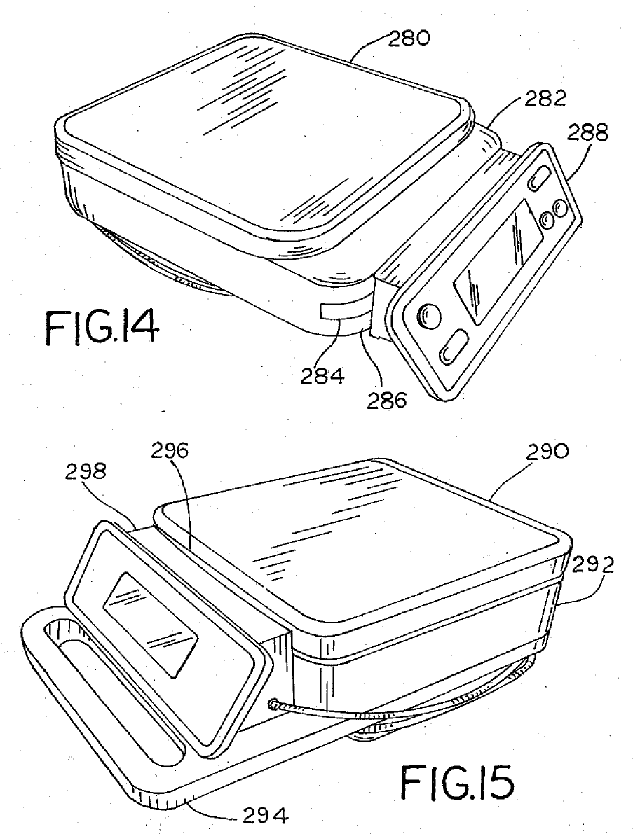

FIGS. 14-19 show further examples of digital scales having alternative configurations, arrangements, and combinations of the features and accessories described and shown above. In FIG. 14, a digital scale 280 includes an instrumentation housing 282 having a horizontal slot 284 formed in a lateral side 286 for releasable engagement with a projection (not shown) from a user interface housing 288. FIG. 15 depicts a digital scale 290 with an instrumentation housing 292 having an integrated handle 294 extending from a lateral side 296 to which a user interface unit 298 is detachably secured. Because the user interface unit 298 rests upon the handle 294 in this example, the user interface unit 298 may alternatively or additionally engage part of the handle 294 to secure its position. Despite lying below the user interface unit 298, the handle 294 may still be spaced from the underlying surface upon which the scale 290 rests, inasmuch as the instrumentation housing 292 includes a support base or footing 299 that also provides cord management functionality. The scale 280 and other alternative scales of FIGS. 14-19 may have a similar support base or footing.

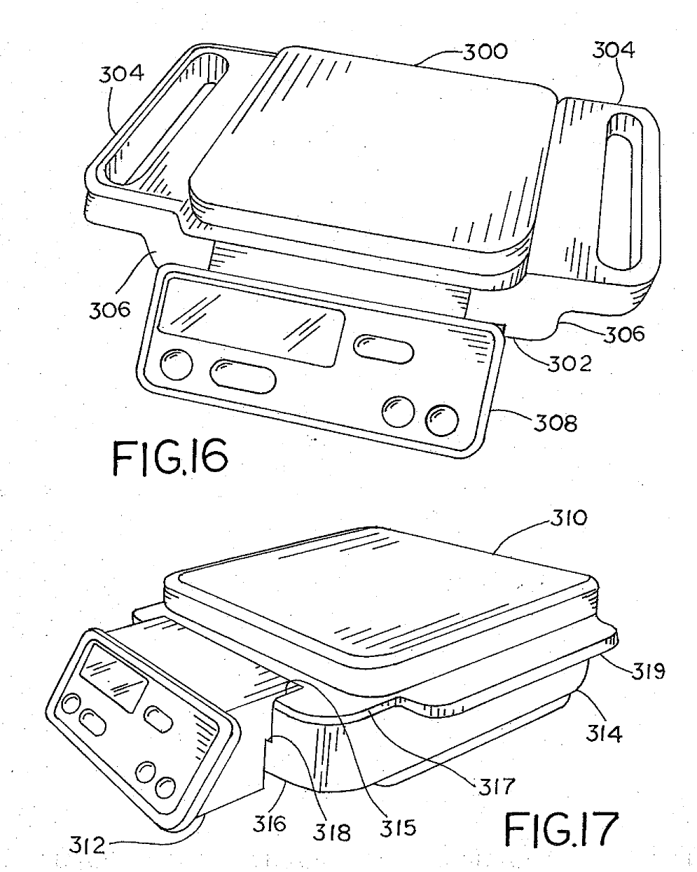

FIG. 16 depicts a scale 300 having an alternative handle arrangement. In this case, an instrumentation housing 302 of the scale 300 has a pair of integrated handles 304 extending laterally from opposing, lateral sides 306. A user interface unit 308 may be fixedly or removably attached to a front side of the instrumentation housing 302 opposite that of a rear side upon which the scale 300 can be stored. To that end, one or more side feet (not shown) similar to those described above may be positioned on the rear side.

FIG. 17 depicts a scale 310 with a user interface unit 312 removably engaged with an instrumentation unit 314 via an alternative structural arrangement. Instead of a depression or recessed panel, the instrumentation unit 314 has an indentation 315 in a lateral side 316 and a top side 317 in which the user interface unit 312 is received. In this way, the user interface unit 312 rests upon a shelf 318 formed by the indentation 315 for a stable, robust connection. The user interface unit 312 may attach to the shelf 318 or any other surface within the indentation 314 by any desired mechanism. For example, the shelf 318 may have one or more upward projecting posts or other structures configured to engage complementary sockets (not shown) in the user interface unit 312. A magnetic connection may alternatively or additionally be utilized.

The scale 310 also includes one or more handles 319. Each handle 319 extends laterally from a lateral side of the instrumentation unit 314. In cases having two handles, the handles 319 may extend from opposite lateral sides. In this example, each handle 319 is shaped as a wing of the lateral side from which it extends, and may be integrally formed therewith. In this way, each handle 319 provides a finger-grip surface, as opposed to the bar-shaped handles described above and configured to be grasped by a user's full hand. Using the finger-grip surfaces of two handles 319, a user can lift and carry the scale 310 in an upright orientation (rather than the orientation described above in which the scale is carried on end). Any one of the scales described herein may be constructed with the finger-grip handle 319 shown in FIG. 17 or the hand-grasp handles described above.

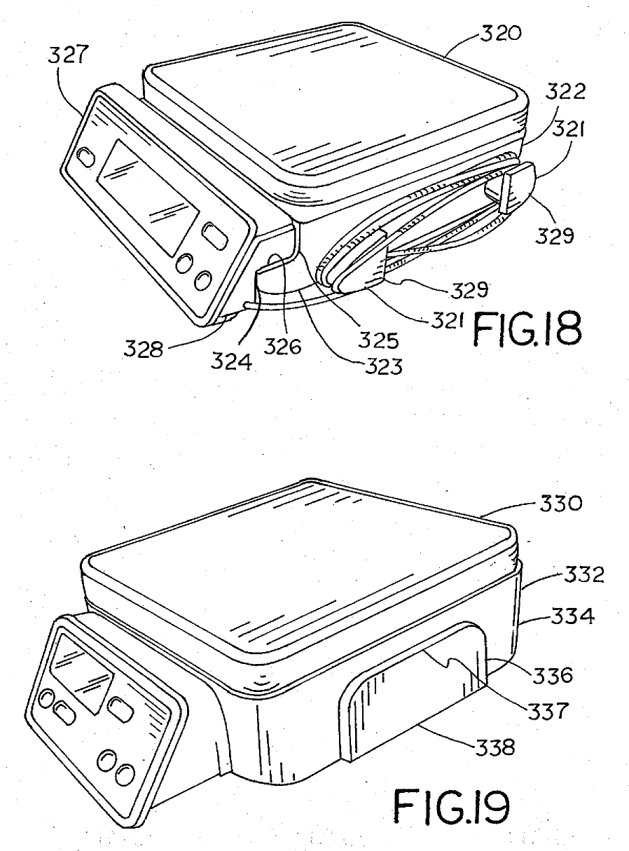

With reference now to FIG. 18, a scale 320 includes cord management brackets or hooks 321 mounted on a lateral side 322 of an instrumentation housing 323. A front side 324 of the housing 323 has a step 325 that forms a ledge 326 upon which a user interface unit 327 is detachably mounted. The ledge 326 may be configured to form an engagement with the user interface unit 327 similar to that described above in connection with the embodiment of FIG. 17, except that the ledge 326 runs the entire length of the front side 324. When mounted, the user interface unit 327 may contact the underlying surface upon which the instrumentation housing 323 rests. As a result, the cord or cable connecting the user interface unit 327 to the instrumentation housing 323 may emanate from a lateral side 328 of the user interface unit 327.

The scale 320 may also be stored on the lateral side 322, as the cord management hooks 321 include flat surfaces 329 that can act as storage feet. Any one of the scales described herein may integrate the storage feet and cord management features described above in this way.

FIG. 19 depicts a scale 330 having an alternative lateral side configuration. More specifically, an instrumentation housing 332 has one or more lateral sides 334 from which a flat handle 336 protrudes. Each handle 336 generally provides finger-grip or handle surfaces 337, 338 to help a user carry the scale 330 in an upright orientation. The profile of the handle 336 differs from the finger-grip handle 319 (FIG. 17), inasmuch as the handle 336 does not extend much from the lateral side 334, and the handle surfaces 337, 338 are spaced a considerable distance from one another. As a result, the handle 336 may configured, when viewed from the front, with a depth and a height that considerably exceeds the width, or distance that the handle 336 extends from the lateral side 334. In this example, the handle 336 is dimensioned such that it covers or extends across most of the lateral side 334.

Because of its considerable spread across the lateral side 334, the handle 336 may also act as a storage foot to support the instrumentation housing 332 in a storage orientation. To that end, the handle 336 may have an outward surface area sized to stably support the instrumentation housing 332 when placed on the lateral side 334. The comparably minimal extent to which the handle projects from the lateral side 334 can also ensure that the handle 336 acts as a stable base or foundation in the storage orientation. The storage feet and handle features of the disclosed scales may be integrated in this way for any one of the scales described above.

With the pressure-fit, snap-fit, magnetic and other connections described above, each of the exemplary digital scales may have one or more housings or enclosures sealed to a waterproof or watertight extent. The sealing may generally facilitate use in a variety of messy or dirty environments and contexts. The sealing may also be configured to withstand cleaning in a dishwasher. With dishwasher-safe designs, the disclosed scales may be cleaned more conveniently and frequently.

The dishwasher-safe aspect of the disclosed scales may involve the disconnection of the user interface unit. During dishwasher or other cleaning, the interface unit is detached as described above, and may also be disconnected from the instrumentation housing by unplugging the communication and/or power cord. In this way, the interface unit need not be subjected to the heat and other conditions inside a dishwasher. The interface unit may nonetheless be watertight or waterproof to accommodate uses in which the interface unit may be subjected to spills, wipedowns, or other contact with liquids.

A variety of materials may be used to construct the components of the disclosed scales. In some cases, the scale housings or enclosures may be formed from components made of bent sheet metal, stamped metal, or cast metal, as well as injection-molded plastic parts and rubber parts. As described above, rubber over-molding may be used at corners or other locations of the housing to facilitate handling, storage, or the above-described sealing.

As described above, the non-mechanical technique for connecting and disconnecting the interface unit also increases the structural integrity of the scales, while simplifying the interface for easy cleaning and use. The cord management system allows the user to wrap the cord around the bottom of the scale to keep it cleaner and out of the way. The integral handle supports better handling and transport of the scale, which, in turn, reduces the amount of damage resulting from drops and other undesirable contact.

The exemplary digital scales described and shown herein may include one or more rechargeable batteries to further facilitate portability.

The foregoing aspects of the disclosed digital scales generally facilitate cleaning and secure and convenient handling and storage despite the features thereof that may otherwise complicate such use (e.g., a detachable digital display unit, a detachable platform, etc.). Although some of the features of the disclosed digital scales shown and described are particularly well-suited for portioning scales, practice of the disclosed aspects are well-suited for use and incorporation into a variety of scale types (e.g., legal-for-trade scales, ingredient scales, etc.). With each of these scale types, and in each of the respective contexts, the features of the scales described above are configured, arranged or provided in a manner that avoids making the scale harder to clean, move, or store. The combinations of the above-described features and accessories may vary as desired, such that a selected subset of the features may be incorporated into a scale constructed in accordance with the disclosure.

Although certain devices have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A scale for a weight measurement of a load, the scale comprising:
an instrumentation housing;
a platform base spaced from the instrumentation housing for movement during the weight measurement via application of the load; and,
a platform configured to support the application of the load, the platform being attached to the platform base via a snap-fit connection;
wherein the platform is detachable from the platform base to separate the platform from the instrumentation housing via a release of the snap-fit connection.

2. The scale of claim 1, wherein the platform base comprises a platform-shaped undercarriage.

3. The scale of claim 2, wherein the platform comprises a cap configured to cover the undercarriage.

4. The scale of claim 1, wherein the platform base and the platform are shaped to stack in a nested arrangement.

5. The scale of claim 1, wherein the platform base comprises a lever configured to release the platform by disengaging the snap-fit connection.

6. The scale of claim 5, wherein the lever comprises a ramp engaged by the platform in the snap-fit connection.

7. The scale of claim 1, wherein the platform comprises a plurality of sides, each side having a tab for engagement of the platform base in the snap-fit connection.

8. The scale of claim 7, wherein the plurality of sides are arranged symmetrically to facilitate the engagement of the platform base in a plurality of orientations.

9. The scale of claim 1, wherein the instrumentation housing comprises a carrying handle extending from a side of the instrumentation housing, and wherein the snap-fit connection is configured such that the platform can remain attached to the platform base while the instrumentation housing is carried via the carrying handle.

10. A scale for a weight measurement of a load, the scale comprising:
an instrumentation housing;
an undercarriage platform spaced from the instrumentation housing for movement during the weight measurement via application of the load; and,
a cap platform releasably attached to the undercarriage platform to support the application of the load;
wherein the platform cap and the undercarriage platform are shaped to stack in a nested arrangement such that the platform cap covers the undercarriage platform.

11. The scale of claim 10, wherein the undercarriage platform and the cap platform are attached via a snap-fit connection.

12. The scale of claim 10, wherein the undercarriage platform comprises a lever configured to release the cap platform.

13. The scale of claim 10, wherein the lever comprises a ramp engaged by the platform.

14. The scale of claim 13, wherein the platform comprises a plurality of sides, each side having a tab configured for engagement of the ramp of the platform base.

15. The scale of claim 14, wherein the plurality of sides are arranged symmetrically to facilitate the engagement of the platform base in a plurality of orientations.

16. The scale of claim 10, wherein the instrumentation housing comprises a carrying handle extending from a side of the instrumentation housing.
